(19) United States
(12) Patent Application Publication
(10) Pub. No.: US 2007/0190518 A1
(43) Pub. Date: Aug. 16, 2007

(54) HYPOTHERMIC TOOTH TRANSPORT SYSTEM

(75) Inventors: Jason P. Bourgeois, Proctorsville, VT (US); John J. Beaulieu, Ludlow, VT (US); Robin L. Crossman, North Chittenden, VT (US)

Correspondence Address: BURNS & LEVINSON, LLP, 125 SUMMER STREET, BOSTON, MA, 02110, US

(73) Assignee: BABYTOOTH TECHNOLOGIES, LLC, Proctorsville, VT (US)

(21) Appl. No.: 11/611,789

(22) Filed: Dec. 15, 2006

Related U.S. Application Data
(60) Provisional application No. 60/750,661, filed on Dec. 15, 2005.

(51) Int. Cl. A01N 1/02; A61C 5/00

(52) U.S. Cl. 435/1.1; 433/217.1

(57) ABSTRACT

The present invention relates to a method, system and container apparatus that enables sustained cellular viability of tooth biology under hypothermic conditions while providing a matrix nutrient specific to teeth environment that autonomously prepares cells and tissues for the cryogenic freezing process, in vitro

### RELATED APPLICATIONS

The present application claims priority from U.S. Provisional Patent Application number 60/750,661, filed Dec. 15, 2006.

### FIELD OF THE INVENTION

The present invention generally relates to biological tissue transport. Specifically, the present invention relates to a container system and related method that effects sustained cellular viability of interior and exterior tooth cells under hypothermic conditions while providing a matrix nutrient environment that autonomously prepares cells and tissues for a cryogenic freezing process, in vitro.

### BACKGROUND OF THE INVENTION

With the recent discovery of multi potent adult stem cells in the dental pulp chamber of baby teeth and wisdom teeth, and also the discovery of stem cells in the Periodontal Ligament of Wisdom and Adult teeth and including other useful oral cells, there is an increasing trend for long term cryogenic preservation of these types of cells for later use in future medical treatment.

When a tooth is removed from the oral cavity by either natural or accidental exfoliation or by means of surgical extraction, the health of a tooth immediately declines, ending in total death of the tooth within 15 to 30 minutes. Therefore, in cases of emergency tooth loss or otherwise, a sustaining method of transporting teeth is required to preserve tooth cell viability for extended periods of time. Prior systems for tooth transport are limited to the use of saline solution products at ambient temperature for the preservation of periodontal ligament cells for 24 hours maximum and without the inclusion of hypothermic conditions and a proper matrix nutrient environment which is optimal for successful transport of other dental tissues that exist within and upon a tooth.

Clinical grade milk has been proven to be adequate for sustaining the life of a tooth during multi-day transport and is upon occasion compatible with certain applications of cryogenic freezing, however, washing of a tooth is necessary, which can potentially destroy the existing healthy cells. Commercial grade milk is not recommended because it may introduce the possibility of contamination which in turn would need to be both sterilized and washed away from the tooth before a cryo-protectant can be adequately applied. Milk may contain diseases and harmful bacteria such as e-coli, whereas other ‘sterile’ fluid is to be considered that can provide longer transport durations as well as provide direct chemical compatibility for the cryogenic process which reduces cell stress and possible cell damage, which the use of common milk can not avoid.

Additional and alternate sources of transport nutrients comprise (a) albumin, (b) protein based, enzyme sufficient fluids, c) egg yolk, and other organic liquids may be used. As mentioned previously, the necessary washing needed to remove these fluids may harm the viability of both internal and external cells and therefore it is recommended that a cryogenically compatible counterpart be used. Also, albumin, protein based, enzyme sufficient fluids, egg yolk, and other organic liquids must be of clinical grade only to ensure best results.

Cold chain hypothermic transport methods currently exist for long term storage of biological tissues and cells, although no current art provides adequate means or information for the successful transport and related interim storage of teeth that accounts for sustained cellular viability of interior and exterior tooth cells under hypothermic conditions while providing a matrix nutrient environment that simultaneously prepares cells and tissues for the cryogenic freezing process, in vitro.

### SUMMARY OF THE INVENTION

The present invention overcomes the previous limitations by providing a container system and related method that effects for sustained cellular viability of interior and exterior tooth cells under hypothermic conditions while providing a matrix nutrient environment that simultaneously prepares cells and tissues for the cryogenic freezing process, in vitro. The present invention sustains the post-oral life-span of tooth pulp and applicable tooth biology with minimal loss and maintaining maximum cell viability during transport and/or storage.

One embodiment of the present invention provides method for transporting teeth and maintaining viability of cells located therein, comprising the steps of: containing a nutrient solution for holding a tooth within a first closable vial; locating the first vial within a second closable vial; and supporting the first vial within the second vial with a biasing mechanism adapted to cause the first vial to move upwardly and to slightly protrude from the second vial when the second vial is open.

The first and second containers may be vertically elongated and concentrically located, and the method may further comprise the steps of locating the first and second vials within an insulating container having an open chamber, and at least partially laterally surrounding the first and second vials by chilled thermal material that is kept separated from the vials within the open chamber.

The biasing mechanism may be adapted to prevent contact between a base of the first vial and the second vial and is a thermal conduction insulator. The biasing mechanism may be one or more cotton balls or a spring mechanism.

The first and second vials may each have a lower interior wall that is conically shaped. The method may further comprise the step of leaving an empty gap in the first vial above the nutrient solution to allow a layer of insulating air or other gas between the solution and a top of the first vial.

The nutrient solution may be protein and sera free and may be adapted for cellular osmosis of teeth and is chemically compatible with a cryopreservative. The nutrient solution may include HYPOTHERMOSOL.

The method may further comprise the step of suspending a porous fabric container for holding a tooth within a nutrient solution. The step of suspending may include suspending the fabric container from a periphery of a top of the first vial.

Another embodiment of the present invention provides a method for transporting teeth and maintaining viability of cells located therein, comprising the steps of: maintaining a tooth within a protein, sera free nutrient solution adapted for cellular osmosis of teeth and being chemically compatible with a cryopreservant; containing the nutrient solution and any tooth therein within a first closable vial; locating the first vial within a second closable vial; and locating the first and second vials within an insulating container having an open chamber, and at least partially laterally surrounding the first and second vials by chilled thermal material. The nutrient solution may include HYPOTHERMOSOL.

Another embodiment of the present invention provides an apparatus for transporting teeth and maintaining viability of cells located therein, comprising: a closable first vial adapted for holding a tooth in a nutrient solution; a second closable vial adapted for containing the first vial; and a biasing mechanism adapted for supporting the first vial within the second vial to cause the first vial to move upwardly and to slightly protrude from the second vial when the second vial is open.

The first and second containers may be vertically elongated and concentrically located, and the apparatus may further comprise an insulating container having an open chamber and adapted to enable at least partially laterally surrounding the first and second vials with chilled thermal material with an epicenter of the cooling material collocated with an epicenter of the vials. The thermal material may have a thermal mass which is at least 50 times that of the thermal mass of the first and second vials including the nutrient material and a tooth. The biasing mechanism may be adapted to prevent contact between a base of the first vial and the second vial and is a thermal conduction insulator. The biasing mechanism may be one or more cotton balls or a spring mechanism.

The first and second vials may each have a lower interior wall that is conically shaped. The first vial may be adapted to maintain an empty gap above the nutrient solution to allow a layer of insulating air or other gas between the solution and a top of the first vial. The first vial may include a reflective thermal bottom. The first or second vial may have a thermal insulating top.

The nutrient solution may be protein and sera free and adapted for cellular osmosis of teeth and is chemically compatible with a cryopreservant. The nutrient solution may include HYPOTHERMOSOL.

The apparatus may further comprise a soft, porous fabric container adapted for suspending a tooth in the nutrient solution. Each The fabric container may be suspended from a periphery of a top of the first vial.

Another embodiment of the present invention provides an apparatus for transporting teeth and maintaining viability of cells located therein, comprising: a soft, porous fabric container adapted for suspending a tooth within a nutrient solution; a first closable vial adapted for holding a tooth in a nutrient solution; a second closable vial adapted for containing the first vial; a biasing mechanism adapted for supporting the first vial within the second vial to cause the first vial to move upwardly and to slightly protrude from the second vial when the second vial is open; and. an insulating container adapted for holding the first and second vials within an open chamber, and further adapted for holding chilled thermal material at least partially laterally surrounding the first and second vials

Another embodiment of the present invention provides an apparatus for transporting teeth and maintaining viability of cells located therein, comprising: a protein, sera free nutrient solution adapted for cellular osmosis of teeth and being chemically compatible with a cryopreservant; a first closable vial adapted for containing enough nutrient solution to cover a tooth; a second closable vial adapted for containing the first vial; and an insulating container adapted for containing the first and second vials within an open chamber, and at least partially laterally surrounding the first and second vials by chilled thermal material The nutrient solution may include HYPOTHEROSOL.

Another embodiment of the present invention provides a method of establishing an effective source of multi potent stem cells comprising: harvesting teeth, portions of teeth and related oral cavity tissue of a mammalian host; promptly after such harvesting providing all or a portion of the harvested material with a hypothermic, sterile environment free of sera and protein for transport/storage; providing a cryogenic, sterile storage environment; transforming the material from the hypothermic environment to cryogenic storage environment with minimal breakdown of viability of cells within the material, upon demand retrieving the material from the cryogenic environment with a similar transition to a cell utilization environment with minimized breakdown of viability of cells within the material, implanting material or cells extracted therefrom in a mammalian host, the said step of hypothermic environment provision including suspension of harvested material in a fluent matrix environment containing nutrients accessible to the surface and interior of the harvested material and providing a cooling means spaced from the suspended material and further including provision of thermal insulation also spaced from the harvested material, to establish and maintain a thermic environment temperature of about 34-50 degrees Fahrenheit, in any event above freezing point of aqueous contents of the harvested material, for up to 82 hours under common diverse challenges of ambient conditions of storage or transport and wherein said matrix material of the hypothermic environment is selected for compatibility with the subsequent cryogenic storage step, whereby the conditions of the steps of hypothermic transport/storage maintain cellular viability and autonomously prepare the harvested material for subsequent cryogenic freezing in vitro.

The temperature of the hypothermic environment may be maintained with generation of stored records of at least interval portions of temperature history. The method may further comprise providing an ejection system for sterile specimen receptacle whereby said container is projected slightly from secondary containment receptacle as cap is removed from secondary containment receptacle to accommodate for ease of access to specimen container during use.

The method may further comprise providing a catch system for possible overflow of the matrix material upon inserting harvested material therein to offset the possibility of escape of non-sterile elements, if any, of the harvested material. The absorbent material may be provided in the catch system.

Another embodiment of the present invention provides a hypothermic storage/transport apparatus for mammalian cellular material comprising: a dual walled vessel for containing the material, comprising: (i) primary, water tight receptacle capable of 95 kPa (0.95 bar, 13.8 lb/in2) in the range of −40° C. to 55° and (ii) secondary, water tight containment receptacle capable of the same pressure limits; a fluent matrix material in the vessel; means for suspending the mammalian cellular material in the matrix within the vessel without touching its walls; an air space surrounding the vessel and enclosed by insulating barriers which do not touch the vessel walls, in turn surrounded by exterior surfaces to complete a storage/transport package; and means for cooling the air between the vessel to and maintaining its temperature at about 34-50 degrees Fahrenheit.

The apparatus may further comprise means for monitoring air space and/or wall temperature during at least some intervals transport/storage and means for safe ejection of primary specimen receptacle whereby said container is projected slightly from secondary containment receptacle as cap is removed from containment receptacle during use and includes vial support area and work station.

The current invention overcomes most of these unforeseen variables by providing a hypothermic temperature controlled environment using cooling elements and incorporating adequate design mechanisms.

Other objects, features and advantages will be apparent from the following detailed description of preferred embodiments taken in conjunction with the accompanying drawings,

### BRIEF DESCRIPTION OF THE DRAWINGS

The present invention is illustratively described in reference to the appended drawings in which:

FIG. 1 it is a side schematic view of a primary tooth containment vial constructed in accordance with one embodiment of the present invention;

FIG. 2 is a side schematic view of a secondary containment vial also constructed in accordance with an embodiment of the present invention;

FIG. 3 is a side schematic view of another secondary containment vial constructed in accordance with another embodiment of the present invention; in

FIG. 4 is a top view of a portion of an insulated transport container constructed in accordance with an embodiment of the present invention;

FIG. 5 is a side view of the member shown in FIG. 4;

FIG. 6 is a side view of an insulated transport container constructed in accordance with an embodiment of the present invention and using the member shown in FIGS. 4 and 5;

FIG. 7 is a top view of the transport container of FIG. 6; and

FIG. 8 is a top plan view of another insulated transport container constructed in accordance with an embodiment of the present invention.

### DETAILED DESCRIPTION OF PREFERRED EMBODIMENTS

There is a need, met by embodiments of the present invention, for an optimal nutrient rich environment in which to transport teeth under hypothermic conditions, comprising of adequate cold chain cooling processes. The specific cold chain cooling process used can be summarized as “cold reflection”. In practice, this dynamic process occurs when two opposing cooling sources are placed within the storage/transport package. This process establishes a physical and functional integrity to accommodate the need for hypothermic conditions in which to transport teeth in an optimal nutrient rich environment. Cold reflection describes an active process which occurs when opposing forces of radiant cold are housed close by in a thermally insulated environment, resulting in achieving the coldest potential which is then directed toward the epicenter of the primary and secondary receptacles to extend durations of cold, as opposed to a solitary ice (or other cold) source.

As described in more detail below, in order for a cold chain cooling processes to achieve an optimal hypothermic environment of 34 to 50 degrees Fahrenheit, an adequate amount of insulation material must be used to house or contain the transport vial. Furthermore, to achieve a consistent temperature within the vial transport compartment, an adequate amount of cooled air space must be allowed. The volume of cooled air within the vial transport compartment should be greater than the volume of the chosen vial being used.

The cooling element should not come in direct contact with the specimens being transported within vial. Therefore, the vial wall is an acceptable barrier to help distance the specimen from the cooling element. Cooling elements can be located in several unique areas within the body of the transport system.

The body of the transport system creates an insulation barrier from exterior climates and furthermore, the interior creates an interior cooled air pocket referred to as the vial transport compartment. The body will be most efficient at 6 inches cubic measurement for a 30 cc vial, whereas vials of other sizes may require the body to be modified in order to obtain adequate hypothermic threshold requirements. The body can be comprised of such poly fiber comprising any one or several of the following moldable materials; styrofoam, polypropylene, polyurethane, AVA, neoprene, PVC, silicone, sponge rubber,wide density range Zotefoams-Evazote & Plastazote, Dow, Ethaform, Oletex, Voltek-Volara, Youngbo, Sentinel, Poron, EPS, anti-static/dissipative/conductive Brock Foam can be used to create an adequate insulation R value for optimal hypothermic temperatures of 34° to 50° Fahrenheit. Other materials may also be considered. Once a precise body size has been calculated and manufactured, the body components comprising one or several machined, drilled and or molded foam pieces are placed into an appropriate corrugated or non-corrugated cardboard box which securely encases the molded body and increases the insulation factors. For shipping and insulation purposes, the body may be placed into a closable flapped foam foil insulation sleeve with Velcro fasteners or cellophane type shrink wrap, or other polymer film material can be applied around the entire invention for said purpose.

A cold chain process is the ability to maintain a consistent temperature within an enclosed area. During national and/or international multi-day transport the cold chain process occurs' within the vial transport compartment of the current invention.

The vial transport compartment is a concealed volume of cooled air directly surrounding the transport vial. This ‘pocket’ of air is cooled by either one or several cooling elements placed within the compartment. The cooling source should not drop below 15 degrees Fahrenheit, because cryogenic (sub zero) temperatures can cause sufficient cell damage for cell death to occur.

The materials which can be used to create the cooled environment comprise of one or several ice packs, gel packs, foam bricks, ice cubes, dry ice, Cubies® (poly fiber pouches containing distilled water) or any other contained, non-leaking frozen material that is of a non-toxic nature. The only limitation of the coolant source is that it may not be of cryogenic (sub-zero) temperature. Although some sources may cool near or absolute zero within the vial transport compartment, to maintain adequate non freezing temperatures of the hypothermic transport medium, appropriate distances must be calculated and tested for each variant of the current invention with the placement of the cooling elements not touching the vial wall. One or several cooling elements can be used for most hypothermic applications wherein the transport of teeth occurs over multi-day periods; however, the inclusion of multiple cold reflection causing elements at least partially surrounding the specimen container and large enough to provide a significant thermal mass or reservoir to the system is preferred.

During multi-day transport there are many variables which, if not accounted for in the transport system and related usage method, may interrupt, impair or ruin the optimal hypothermic transport environment created within this enclosed vial transport compartment. Such occurrences may include but are not limited to; unexpected temperature fluctuations, high heat exposure, exposure to freezing temperatures, flash cooling, flash heating, variable temperatures within transport vehicles, temporary or permanent loss during shipment, gross mishandling, negligence or other less than sufficient circumstances that may develop. To increase the vial transport compartment thermal capabilities, a thermal barrier [preferably comprising polyester material that is durable, acid free, contains no plasticizers and is waterproof] should be placed over the contents of the vial transport compartment, concealing the vial transport compartment before closing the invention for transport. Other plastics may be considered, such as acrylic-styrene-acrylonitrile, ethylene-vinyl acetate, polybutylene-terephtalate, polystyrene, acrylics, Melamine and urea formaldehyde, polycarbonate, polyurethane, acrylonitrile-butadiene-styrene, phenolic, polythylene, polyvinyl chloride, chlorinated polyvinyl chloride, polybutylene, polyphenylene oxide, thermoset polyester, and respective derivatives substituted compounds. Although 3 mil Polyester sheeting cut to the inside dimensions of the corrugated transport box is sufficient for the requirements of providing thermal insulation within the vial transport compartment by creating an impervious air-vapor barrier. Other types of polyester holographic materials may also be added for decorative purposes without distraction to the thermal insulating functions of the invention.

In consideration of potential government regulations and/or emerging private sector standards which may apply, the present invention tracks and records temperatures during multi-day national or international transport utilizing an electronic data collection temperature monitoring device. This temperature monitoring device or its probe is placed within the cooled air of the vial transport compartment to monitor temperatures during transport. This device should be programmable and be able to monitor temperatures as often as once every 60 seconds. Transport times vary for each individual case so it must be factored separately to decide the appropriate settings necessary for each unique scenario. Common temperature tracking strips and other forms of temperature gauges may be used. Adequately, a temperature monitoring device is provided to track potential variances in transport temperatures which may affect overall cell viability during transport, although, removal of a temperature tracking device from the invention will not impair the function of the current system of invention, whatsoever.

The present embodiments provide a sample container filled with a cryogenic compatible, serum free, protein free nutrient matrix solution. Such a solution has the ability to achieve cellular osmosis which assists in cell maintenance and sustains nourishment of both internal and external cells of dental and tooth biology as well as all other cells such as heart, liver, pancreas, lung, kidney and brain cells. Due to its ability to saturate cells via osmosis, by transporting teeth in such a fluid cells are given an optimal chance of survival if maintained at safe hypothermic levels between 34 and 50 degrees Fahrenheit.

Accepted transport solutions can be inserted into the vial using aliquot transfer of appropriate measured quantity. Dissemination of such transport fluids must be completed within a sterile laminar flow hood environment to reduce possible air borne/germ/bacterial contamination. Primary and secondary receptacles and caps have been autoclaved for sterility and pre-chilled to non-destructive hypothermic temperatures (34-50 degrees Fahrenheit). The user should wipe down necessary surfaces with ethanol as required. A user aliquots or pipettes an adequate amount of fluid into pre-chilled primary receptacles. A polypropylene or Thermoset F217 Teflon® Lined cap or equivalent is applied. The primary receptacle is then placed into secondary receptacle for such invented purposes as follows. Appropriately, bulk absorbent material such as cotton (quantity two (2) or more sterile cotton balls) are placed into the secondary receptacle prior to primary specimen receptacle being placed into it. This absorbent material works in combination with conical shape of tube synergistically to create the mechanism which will eject primary receptacle from secondary containment receptacle. The absorbent material is utilized concurrently to contain the full volume of fluent matrix nutrient in the case that leakage of primary receptacle occurs, and creates an adequate apparatus as an ejection system for the primary receptacle. The conical shape of the secondary receptacle combine with the pliable and cushioning effect created by this absorbent material in its position and is capable of applying adequate pressure to primary receptacle which, in effect, causes for slight ejection of the primary receptacle from secondary receptacle as cap is removed from containment receptacle. This ejection capability is optimal in that it allows for ease of access to specimen receptacle and enhances end user compliance. Apart from the pressure caused by this bulk absorbent material similar ejection methods utilizing various apparatus design of alternate forms such as but not limited to metal spring, plastic spring, poly fiber spring, rubber, foam, elastic or other button, latch or screw cap activated ejection systems are unique in purpose to the current system of invention and may be used for the purpose of ejecting We primary receptacle from secondary receptacle, without deterring from the scope of this original step of ejecting the primary receptacle slightly from secondary containment receptacle. Also applied are one or more intrusion alert type security stickers to acknowledge sterility of the transport vial instrument.

Utilizing serum-free, protein free solutions as the preferred transport fluid creates an optimal circumstance which allows for cryogenic preservation compatibility for cells between transport and cryo protective solutions. A preferred such solution is HYPOTHERMOSOL, which is available from BioLife Solutions, Owego, N.Y. Once HYPOTHERMOSOL or the like is applied to the tooth biology, a direct action of osmosis occurs which allows the cells to become fully saturated with HYPOTHERMOSOL. This occurrence is optimal when used in conjunction with its chemically compatible cryopreservant counterpart such as CryoStor, from the same source, or the like.

While utilizing CryoStor or the like, a cryoprotectant which exceeds in the cryogenic process by allowing greater post thaw viability of cells, it is important that we recognize the importance of the relationship between the matrix nutrient transport fluid HYPOTHERMOSOL and the compatible cryopreservant CryoStor,

With the matrix nutrient solution able to penetrate the cellular biology of a tooth, it autonomously prepares the cells for later saturation of the selected cryo-preservative required for the cryogenic process. It must be noted that no washing away of the matrix nutrient is necessary prior to submersion of the tooth into cryo-preservative. This non-washing procedure allows for greater cell viability and lessens the mutilation which in turn lowers the possibility of cell damage. Additional enzymes, chemicals and/or nutrients can be added to enhance cell viability

Although the combination of utilizing HYPOTHERMOSOL and CryoStor creates an optimal cryogenic freezing protocol for compatibility between matrix nutrient and cryopreservative, other cryoprotectants can be used comprising of one or more agents selected from the group consisting of sucrose, trihalose, lactose, glucose. DMSO, propylene glycol, ethylene glycol, a dextran, glycerol, hydroxyethyl starch, polyvinyl pyrrolidone, formamide, 1-2-propanediol, ethanol, methanol, and polyethylene, once the entire tooth has been washed of any and all transport mediums.

Prior to placing a tooth into the transport system of the present invention, the tooth must be removed from the mouth of the participating agent (person). This can occur through natural exfoliation, accidental avulsion and scheduled oral surgery extraction. Although he health of a tooth can vary depending on the health and history of the agent, it is mandatory that, whichever transport medium is chosen, once a tooth is retrieved the agent's tooth (teeth) must be placed into the current system of invention as soon as possible, not exceeding 15 minutes, to sustain any cells and tissues which may be present and alive. The longer an agent waits to provide the tooth (teeth) with the appropriate methods and elements as expressed in this system of invention, the lower the chances of maximum cell survival.

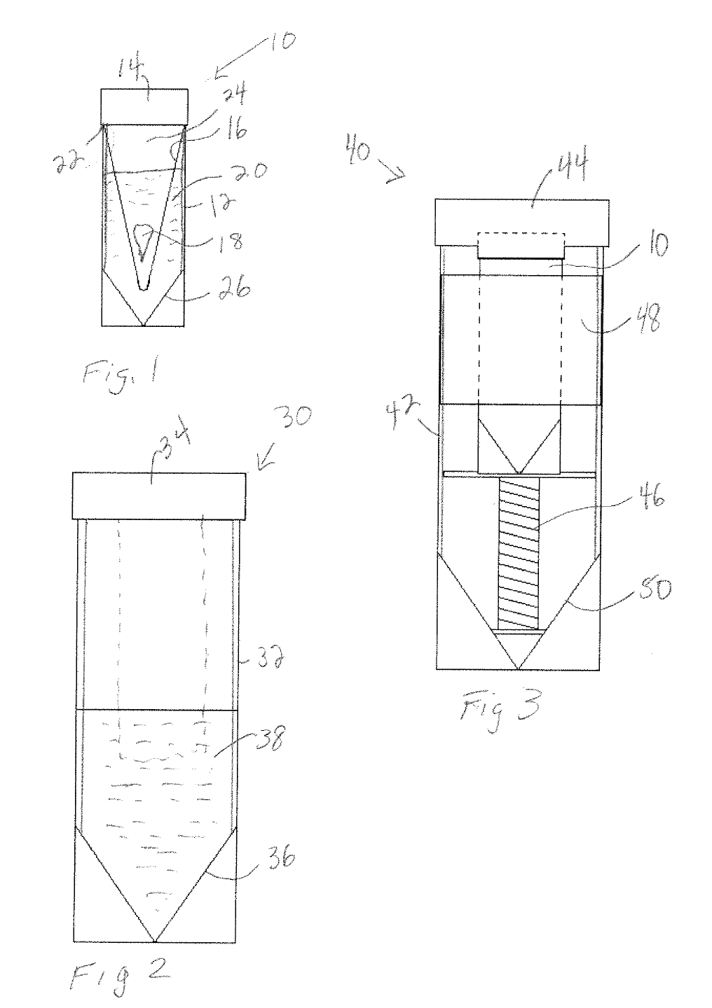

FIG. 1 shows a schematic side view of a primary tooth transport vial 10 generally including a cylindrical body at 12 and a top 14. Suspended within vial 10 is a soft, porous fabric container 16 adapted for supporting a tooth 18 within a matrix nutrient solution 20. Fabric container 16 is suspended from the upper periphery 22 of vial 10 and is conical in shape.

The fabric container 16 preferably comprises a non-absorbent porous mesh constructed from nylon or polypropylene material or other materials acceptable to the United States Food and Drug Administration is suspended from a periphery of a top of the first vial. A preferred embodiment of the fabric container includes a molded, or otherwise manufactured cylindrical nylon ring which is set atop or within the mouth of the first vial and includes a non-absorbent porous nylon mesh which extends from the periphery location in conical form and ending towards bottom of first vial with a rounded collective bottom

Nutrient solution 20 fills most of vial 10 but leaves an upper space 24 which provides an insulating air layer between nutrient solution 20 and top 14. Vial 10 has and interior wall which is conical in shape 26 at the base of vial 10.

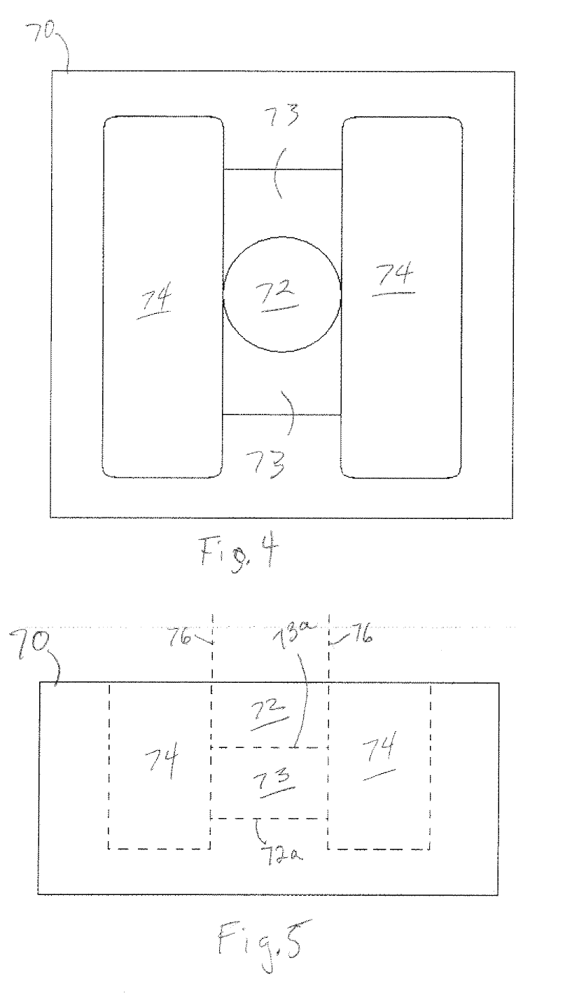

FIG. 2 shows a side schematic view of a secondary or outer transport vial 30, which generally includes a cylindrical body 32 and a top 34. Vial 30 includes a conically shaped bottom 36 and is shown to be partially filled a with un-spun cotton 38. Cotton 38 acts as a moisture absorbing material, as padding for the support of vial 10 within vial 30 and also as a bias mechanism for pressing vial 10 upwardly against top 34. This biasing process enables vial 10 to be protruded from the top of vial 30 when 34 is removed. The conically shaped bottom 36 slopes to direct pressure from the compressed cotton upwardly against top 34.

FIG. 3 shows a side schematic view of another secondary vial 40 constructed to contain primary vial 10 generally including a cylindrical body 42 and a top 44. Also enclosed within vial 40 is a spring mechanism 46 adapted to bias vial 10 upwardly against top 44 and to cause vial 10 to protrude from vial 40 with the removal of top 44. Further enclosed within vial 40 is a cylindrical mass of absorbent material 48 such as un-spun cotton. Vial 40 also includes a conically shaped interior wall 50 at its base, which cooperates with spring mechanism 46 to keep mechanism 46 centered within vial 40. By this arrangement, primary vial 10 is concentrically located within secondary vial 40, and the elongated epicenters of each vial are co-located.

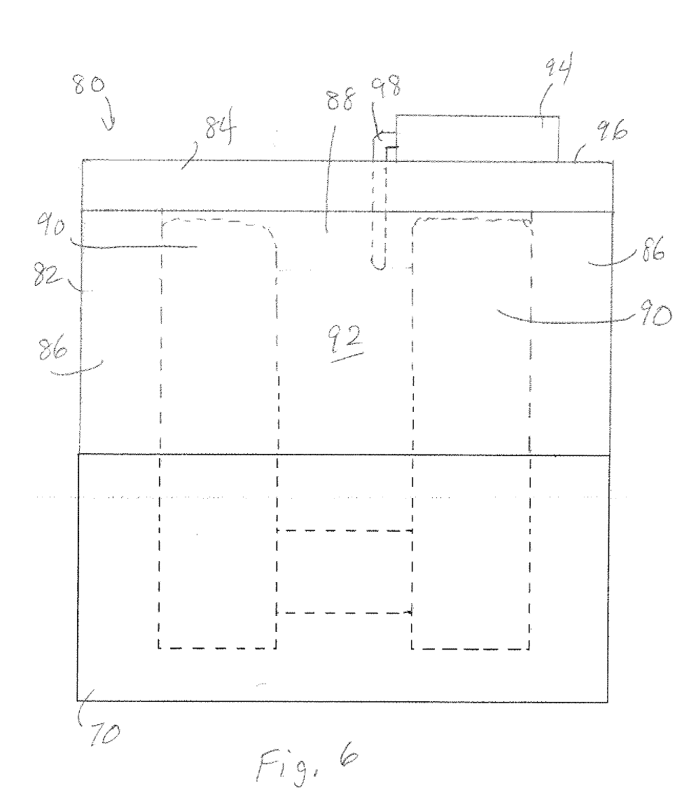

FIG. 4 is a top view of a bottom portion 70 of an insulated transport container adapted for transporting vials 30 and 40. Portion 70 is generally formed from a block of insulating material, such as Styrofoam, and includes a central cavity 72 adapted for locating either of the secondary containment vials 30 or 40 from FIGS. 2 and 3, and a pair of cooling element chambers 74 located on opposing sides of vial cavity 72. Also shown are a pair of supporting members 73 located between coolant chambers 74 and around vial chamber 72. By this arrangement, the epicenter of coolant elements located in chambers 74 are co-located with the elongated epicenters of vials located in cavity 72. The centers of thermal mass are likewise co-located.

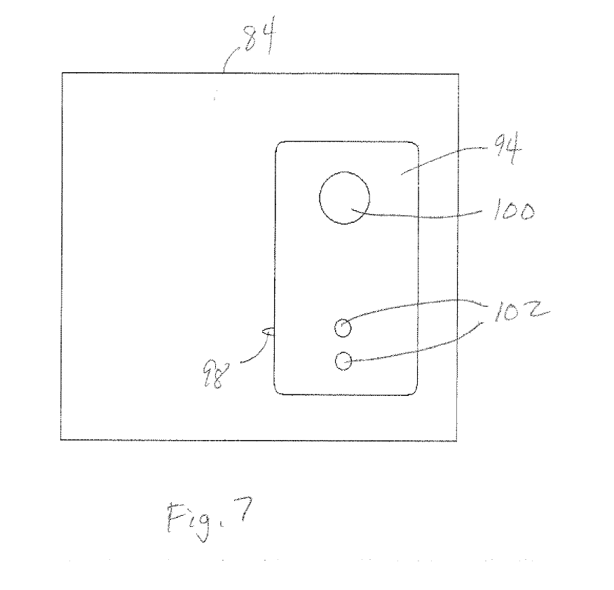

FIG. 5 shows a front view of the portion 70 of FIG. 4, with chambers 72, 74 and supports 73 shown in phantom. Vial container recess 72 extends downwardly to line 72a, and lateral supports 73 extend upwardly to line 73a. In this arrangement, a vial located within recess 72 and cooling elements located within chambers 74 would extend upwardly along lines 76 and thereby be in direct contact with each other.

FIG. 6 is a side view of an insulating transport container 80 constructed with the bottom portion 70 shown in FIG. 5. Also included in container 80 are a center portion 82 and a cover 84. The center portion 82 primarily extends outer walls 86 upwardly from bottom portion 70 to further form the transport chamber 88 for holding coolant elements 90 and a transport vial (not shown) in central chamber area 92. The top of center portion 82 is closed by cover 84. Cover 84 includes a temperature tracking instrument 94 affixed to the top 96 of cover 84 and having a probe 98 adapted to extend through cover 84 and into chamber 92.

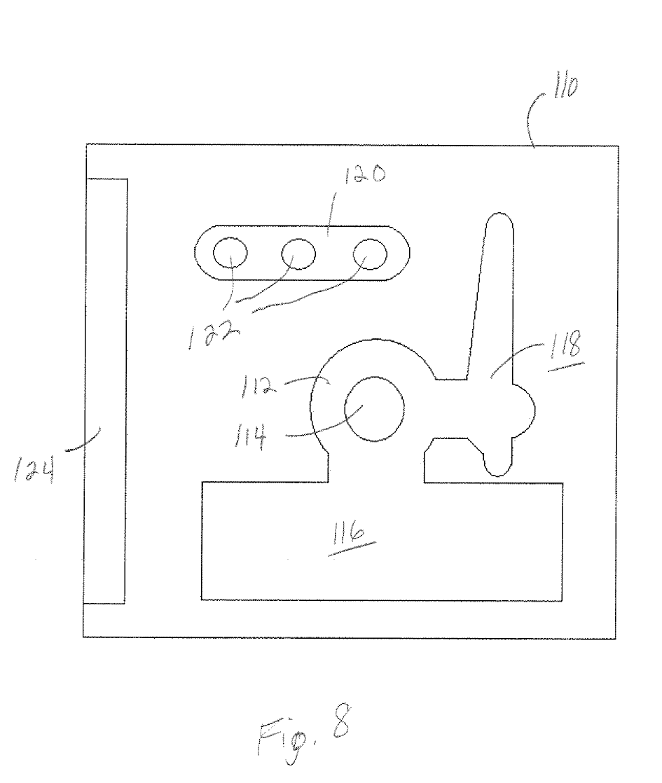

FIG. 7 shows a top view of cover 84 including temperature tracking instrument 94 having an actuator bottom 100 used for controlling the operation of instrument 94 and a pair of indicator lights 102 to indicate temperature conditions being measured within container 80 by probe 98. Any suitable temperature monitoring/recording device may be used, and it may be affixed to cover 84 by any suitable method.

FIG. 8 shows a top plan view of another insulated container 110 adapted for use with various embodiments of the present invention. Generally included in the plan view of container 110 are a specimen chamber 112 having a recess 114 adapted to stabilize a vial, such as the vials 30, 40 of FIGS. 2 and 3. Specimen transport chamber 112 is open to a coolant material chamber 116. Central chamber 112 is further open on another side to an instrument chamber 118 for location of a temperature tracking instrument. Container 110 farther includes a storage area 120 for transporting blood samples by locating separate blood containing vials (not shown) into recesses 122. An accessory compartment 124 is further shown for enclosing complementary items such as instructions for use of container 110, sterile gloves, return address labels, etc.

Method of Use

Prior to placing a tooth into the transport system of the present invention all materials provided during assembly should be introduced at optimal hypothermic temperatures of 34-50 degrees, including the addition of applicable essential instruments of the invention and non-essential elements such as labels, barcodes, identification, packaging materials, during shipment preparation time and shipping procedures. Also, any person or tool which handles the tooth must be sterile and handled in an aseptic environment. Vinyl gloves, which fit conveniently into the transport system of the present invention, may be provided must be used by any person who handles the tooth during the time of tooth exfoliation/extraction and also the time said tooth is placed into the present invention. At this time, a patient's blood sample may or may not be drawn and included into the invention in an area designed specifically to accommodate blood sample transport. While transporting tooth biology it is imperative to achieve a non-hazardous environment acceptable for commercial transport of biological materials. Therefore, no contaminants, fluids or biological matter may remain on or become loose upon any surfaces of the invention.

It is expected that when teeth are placed within the vial of current invention, a certain volume of matrix nutrient may be displaced due to possible overflow of fluids. To lessen the possibility of spreading this fluid, which may now possibly be contaminated due to the presence of an un-sterile tooth, adequate precautions must be taken.

To overcome these scenarios, an absorbent material must be used to absorb the overflow of the possibly contaminated matrix nutrient that may spill, with the capacity of the absorbent material capable of containing the entire volume of fluid within the primary receptacle if necessary. This absorbent material can be applied around the circumference of the neck, midsection or base of the primary specimen receptacle, creating a tight seal around the vial. This can be achieved by punching a hole into the absorbent material the same size as the circumference of the vial. This absorbent material can then be placed at the base of the vial or anywhere along the neck of the vial. Absorbents are insoluble materials or mixtures of materials used to recover liquids through the mechanism of absorption, or adsorption, or both. Absorbents are materials that pick up and retain liquid distributed throughout its molecular structure causing the solid to swell (50 percent or more). The absorbent must be at least 70 percent insoluble in excess fluid. Adsorbents are insoluble materials that are coated by a liquid on its surface, including pores and capillaries, without the solid swelling more than 50 percent in excess liquid

A polymer type of either hydrophilic or hydrophobic, influences the inherent absorbent properties of the fabrics. A hydrophilic fiber provides the capacity to absorb liquid via fiber imbibitions, giving rise to fiber swelling. It also attracts and holds liquid external to the fiber, in the capillaries, and structure voids. On the other hand, a hydrophobic fiber has only the latter mechanism available to it normally. The effect of the small amount of fiber finish (generally 0.1 to 0.5% by weight) is also important since it is on the fiber surface. The particular finish applied on the fiber can significantly change surface wetting property of the fiber.

Concerning absorbent materials, fiber surface morphology, surface ruggedness, and core uniformity can influence the absorbency performance to some extent. Fiber crimps influence the packing density of the fabrics and further affect the thickness per unit mass that affects the absorbency of the non-woven fabrics. The nature of the crimps, whether it is two-dimensional or three-dimensional, also has some effect.

The size of absorbent capillaries is affected by the thickness per unit mass and the resiliency of the web, and the size, shape and the mechanical properties of the absorbent fibers. The resiliency of the web is influenced by the nature and level of bonding of the fibers as well as the size, shape, and mechanical properties of the constituent fibers.

One or several types of absorbent materials which may be used in the present invention include organic absorbents comprising of cotton, wool, paper, hemp type fibers; natural inorganic absorbents clay, perlite, vermiculite, glass wool, sand, or volcanic ash.

Other synthetic absorbents comprising cross-linked polymers and rubber materials, which absorb liquids into their solid structure, causing the absorbent material to swell may also be considered.

To limit the possibility of contamination leakage, the inside walls of the shipping box that houses the invention may or may not be lined with a thin leak tight layer of plastic or plastic bag type of fluid recovery system.

Once a tooth has completed its necessary transport duration, the tooth must be removed from the chosen container within a laminar flow hood environment of a sterile cryogenic processing and storage facility, or tooth processing facility.

Within a sterile laboratory setting, in the confines of a laminar flow hood environment, a technician wearing adequate sterile clothing and gloves will remove the teeth from the shipping container by spilling its contents into a metal funnel which is a chilled between 34 to 50 degrees Fahrenheit.

This funnel will be used to separate tooth biology from the transport fluid while directing the transport fluid into a sterile holding tank of preferably stainless steel material. The funnel and holding tank must be at adequate hypothermic temperature of 34 to 50 degrees Fahrenheit.

The teeth are then removed from the funnel and certain tests for cell viability may be conducted. Certain drop tests may be performed on each tooth. By obtaining a small quantity of tooth biology onto a standard microscope slide, microscopic examination may determine if the tooth is still alive. As stated earlier, many unexpected circumstances can arise which may inhibit or end the life of a tooth, therefore thorough inspection must be completed before proceeding onto the cryogenic freezing process. This testing requires a tooth to be exposed to air and the amount of time a tooth can exist within this unsterile environment is limited to no more than 15 minutes total. Therefore, throughout inspection and testing, a tooth may need to be gently bathed in the holding fluid no less than every minute or as proven otherwise to provide all available living cells with nourishment. Special care is to be taken to limit cell loss by the ‘washing away’ affect of this process. It has been noted that stem cells reside in the blood vessels of dental pulp and therefore limited bathing is preferred. The importance of this section is to not expose cells and tissues to a detrimental and possibly harmful environment apart from the solutions in use during processing procedures. Cells that are lost into the holding fluid will be gathered in a later step by centrifuging.

Once the status of a tooth is obtained, a healthy tooth may continue onto the preparation and cryogenic process, while “dead” teeth will be logged and discarded.

If the tooth is a deciduous tooth (first generation tooth found in children), the pulp may be gently removed from the cusp located at the bottom of the tooth neck using a scraping effect with an appropriate dental pick. If the tooth is of an adult molar the following procedure must be implemented. Utilizing an orbital dental burr each tooth is then prepared by exposing the dental pulp cavity that exists below the crown of a tooth.

Holding the molar tooth using either sterile tongs, pliers, a chuck device or manual/air pressure/hydraulic clamping mechanism the first cut will be introduced approximately 1 to 2 mm below the top of the tooth, into the bulk enamel/dentin complexities of a tooth's crown. Another approach to this segmentation is to cut the tooth beginning at the middle of the roots and continuing the cut over the top of the tooth and ending at the similar other side between the roots. Delicate and precise etching techniques must be performed to ensure that the dental pulp is not harmed by the excessive stress which can be caused by friction heat or accidental puncture. In any case, the tooth is separated and the pulp chamber is revealed.

When the dental pulp cavity is fully exposed with crown removed, the roots can then be severed from the tooth at the dentin/enamel conjunction. This second cut creates two separate pieces of tooth biology:

1) a first piece, the neck of the tooth, contains the major pulp cavity. This bulk piece of tooth biology will appear as a disk with dental pulp occupying the center of the disk which then transitions into a dentin layer, ending in an enamel layer. To achieve further saturation of the freezing medium and cryo preservative into the bulk mass of dental pulp, a dental burr can be used to drill venting holes through the enamel and into the dental pulp cavity which will allow for better movement of fluid across the dentin/enamel layer to reach the major pulp cavity; and 2) one or more second pieces, the roots of the tooth, contain various periodontal ligament cells, root cells, stem cells and other viable blood, cell and tissue components.

The two pieces of tooth must be gently rinsed in the HYPOTHERMOSOL reservoir to clear away residues and chips caused during the cutting process.

At this time, the fluid remaining in the holding tank may be centrifuged to recover any cells which may have been washed out of the tissue during transport and bathing procedures.

At this juncture two options are available. One option is to cryo-preserve the remnants of cells, tissues, dentin, enamel and blood as they are without manipulation. This process is preferred for the preservation of the entire biological components retrieved from the teeth without destruction to vital cells which may occur by performing the following. A second option is to use the process of cellular isolation which targets specifically the stem cells of the cellular mass.

Stem cell isolation techniques are described, for example, in U.S. Published Patent Application No. (Pub. No. 2004/0058442 S. Shi et al.H.I.H.) [U.S. Ser. No. 333,522, filed Sep. 22, 2003 as a 35 U.S.C. §371 conversion of PCT/US01/23053] which is incorporated herein by reference. As reported therein at its par. [0028], the pulp tissue is gently separated from the crown and root and then digested in a solution of 3 mg/ml collagenase type I (Worthington Biochem, Freehold, N.J.) and 4 mg/ml dispase (Boehringer Mannheim, GMBH, Germany) for one hour at 37.degree. C. Single cell suspensions were obtained by passing the cells through a 70 .mu.m strainer (Falcon, BD Labware, Franklin Lakes, N.J.). Bone marrow cells, processed from marrow aspirates of normal human adult volunteers (20-35 years of age), were purchased from Poietic Technologies. Gaithersburg, Md., and then washed in growth medium. Single cell suspensions (0.01 to 1.times.10.sup.5/well) of dental pulp and bone marrow were seeded into 6-well plates (Costar, Cambridge, Mass.) with alpha Modification of Eagle's Medium (GIBCO BRL, Grand Island, N.Y.) supplemented with 20% fetal calf serum (Equitech-Bio Inc, Kerrville, Tex.), 100.mu.M L-ascorbic acid 2-phosphate (WAKO, Tokyo, Japan), 2 mM L-glutamine, 100 U/ml penicillin and 100 mg/ml streptomycin (Biofluids Inc, Rockville, Md.), then incubated at 37.degree. C. in 5% CO.sub.2. To assess colony-forming efficiency, day 14 cultures were fixed with 4% formalin, and then stained with 0.1% toluidine blue. Aggregates of .gtoreq.50 cells were scored as colonies, Conditions for the induction of calcified bone matrix deposition in vitro were as reported previously (6). The proliferation rate of sub-confluent cultures (first passage) of DPSCs and BMSCs was assessed by bromodeoxyuridine (BrdU) incorporation for 24 hours, using a Zymed Laboratories BrdU staining Kit (Vector Laboratories, Burlingame Calif.).

The preferred method for preparation is to be determined by the suggestive purposes proposed for using the cells at a later time. In all cases, living cellular matter is obtained for cryo preservation, with option one providing the larger quantity of cellular matter over the later. However, in situations where cellular expansion (the growing out of cells to a larger quantity) is applied, specific methods for cryo preservation must be applied.

Remaining in the laminar flow hood environment, preparations must be made to fill a cryogenic compatible storage vial with a required aliquot of freezing medium. In the case of the current invention, CryoStor (BioLife, New York) is the optimal cryo-preservative being used, although other fluids exist which can be utilized such as one or more agents selected from the group consisting of sucrose, trehalose, lactose, glucose, DMSO, propylene glycol, ethylene glycol, a dextran, glycerol, hydroxyethyl starch, polyvinyl pyrrolidone, formamide, 1-2-propanediol, ethanol, methanol, and polyethylene oxide and egg yolk.

With the body of the tooth prepared, as mentioned, by allowing for a large surface area of dental pulp to be exposed to the cryogenic fluids, it allows for maximum surface exposure of the dental pulp within the CryoStor protectant. In some instances the entire pulp mass may also be separated and removed from the tooth. This pulp mass may be sliced or chopped into smaller pieces as deemed adequate to allow maximum absorption and saturation of the cryo-protectant. This bulk of tooth matter is now adequately prepared for submersion into the CryoStor solution for cryogenic storage purposes. Due to the chemically compatible nature of certain hypothermic transport/cryopreservation fluids, this format of compatibility is the optimal choice.

The roots which have been severed from the tooth will also be placed into the CryoStor vial for cryogenic storage of the periodontal ligament and various biological attachments.

One moves the prepared vials into a controlled rate freezer and begin cryogenic processes allowing for the specimens to be frozen at various controlled and/or uncontrolled rates, or as is further deemed necessary for alternate quantities, weights and sizes of tooth biology which ensure post freezing cellular viability.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. A method for transporting teeth and maintaining viability of cells located therein, comprising the steps of:
containing a nutrient solution for holding a tooth within a first closable vial;
locating the first vial within a second closable vial; and
supporting the first vial within the second vial with a biasing mechanism adapted to cause the first vial to move upwardly and to slightly protrude from the second vial when the second vial is open.

2. The method of claim 1, wherein the first and second containers are vertically elongated and concentrically located, and further comprising the steps of locating the first and second vials within an insulating container having an open chamber, and at least partially laterally surrounding the first and second vials by chilled thermal material that is kept separated from the vials within the open chamber.

3. The method of claim 1, wherein the biasing mechanism is adapted to prevent contact between a base of the first vial and the second vial and is a thermal conduction insulator.

4. The method of claim 3, wherein the biasing mechanism is one or more cotton balls or a spring mechanism.

5. The method of claim 1, wherein the first and second vials each has a lower interior wall that is conically shaped.

6. The method of claim 5, further comprising the step of leaving an empty gap in the first vial above the nutrient solution to allow a layer of insulating air or other gas between the solution and a top of the first vial.

7. The method of claim 1, wherein the nutrient solution is protein and sera free and is adapted for cellular osmosis of teeth and is chemically compatible with a cryopreservative.

8. The method of claim 7, wherein the nutrient solution includes HYPOTHERMOSOL.

9. The method of claim 1, further comprising the step of suspending a porous fabric container for holding a tooth within a nutrient solution.

10. The method of claim 9, wherein the step of suspending includes suspending the fabric container from a periphery of a top of the first vial.

11. A method for transporting teeth and maintaining viability of cells located therein, comprising the steps of:
maintaining a tooth within a protein, sera free nutrient solution adapted for cellular osmosis of teeth and being chemically compatible with a cryopreservant;
containing the nutrient solution and any tooth therein within a first closable vial;
locating the first vial within a second closable vial; and
locating the first and second vials within an insulating container having an open chamber, and at least partially laterally surrounding the first and second vials by chilled thermal material.

12. The method of claim 11, wherein the nutrient solution includes HYPOTHERMOSOL.

13. An apparatus for transporting teeth and maintaining viability of cells located therein, comprising:
a closable first vial adapted for holding a tooth in a nutrient solution;
a second closable vial adapted for containing the first vial; and
a biasing mechanism adapted for supporting the first vial within the second vial to cause the first vial to move upwardly and to slightly protrude from the second vial when the second vial is open.

14. The apparatus of claim 13, wherein the first and second containers are vertically elongated and concentrically located, and further comprising an insulating container having an open chamber and adapted to enable at least partially laterally surrounding the first and second vials with chilled thermal material with an epicenter of the cooling material collocated with an epicenter of the vials.

15. The apparatus of claim 14, wherein the thermal material as a thermal mass which is at least 50 times that of the thermal mass of the first and second vials including the nutrient material and a tooth.

16. The apparatus of claim 15, wherein the biasing mechanism is adapted to prevent contact between a base of the first vial and the second vial and is a thermal conduction insulator.

17. The apparatus of claim 16, wherein the biasing mechanism is one or more cotton balls or a spring mechanism.

18. The apparatus of claim 13, wherein the first and second vials each has a lower interior wall that is conically shaped.

19. The apparatus of claim 18, wherein the first vial is adapted to maintain an empty gap above the nutrient solution to allow a layer of insulating air or other gas between the solution and a top of the first vial.

20. The apparatus of claim 19, wherein the first vial includes a reflective thermal bottom.

21. The apparatus of claim 20, wherein the first or second vial has a thermal insulating top.

22. The apparatus of claim 13, wherein the nutrient solution is protein and sera free and is adapted for cellular osmosis of teeth and is chemically compatible with a cryopreservant.

23. The apparatus of claim 22, wherein the nutrient solution includes HYPOTHERMOSOL.

24. The apparatus of claim 13, further comprising a soft, porous fabric container adapted for suspending a tooth in the nutrient solution.

25. The apparatus of claim 24 in one, wherein the fabric container is suspended from a periphery of a top of the first vial.

26. An apparatus for transporting teeth and maintaining viability of cells located therein, comprising:
a soft, porous fabric container adapted for suspending a tooth within a nutrient solution;
a first closable vial adapted for holding a tooth in a nutrient solution;
a second closable vial adapted for containing the first vial;
a biasing mechanism adapted for supporting the first vial within the second vial to cause the first vial to move upwardly and to slightly protrude from the second vial when the second vial is open; and
an insulating container adapted for holding the first and second vials within an open chamber, and further adapted for holding chilled thermal material at least partially laterally surrounding the first and second vials.

27. An apparatus for transporting teeth and maintaining viability of cells located therein, comprising:
a protein, sera free nutrient solution adapted for cellular osmosis of teeth and being chemically compatible with a cryopreservant;
a first closable vial adapted for containing enough nutrient solution to cover a tooth;
a second closable vial adapted for containing the first vial; and
an insulating container adapted for containing the first and second vials within an open chamber, and at least partially laterally surrounding the first and second vials by chilled thermal material.

28. The apparatus of claim 27, wherein the nutrient solution includes HYPOTHEROSOL.

29. A method of establishing an effective source of multi potent stem cells comprising:
harvesting teeth, portions of teeth and related oral cavity tissue of a mammalian host;
promptly after such harvesting providing all or a portion of the harvested material with a hypothermic, sterile environment free of sera and protein for transport/storage;
providing a cryogenic, sterile storage environment;
transforming the material from the hypothermic environment to cryogenic storage environment with minimal breakdown of viability of cells within the material,
upon demand retrieving the material from the cryogenic environment with a similar transition to a cell utilization environment with minimized breakdown of viability of cells within the material,
implanting material or cells extracted therefrom in a mammalian host,
the said step of hypothermic environment provision including suspension of harvested material in a fluent matrix environment containing nutrients accessible to the surface and interior of the harvested material and providing a cooling means spaced from the suspended material and further including provision of thermal insulation also spaced from the harvested material, to establish and maintain a thermic environment temperature of about 34-50 degrees Fahrenheit, in any event above freezing point of aqueous contents of the harvested material, for up to 82 hours under common diverse challenges of ambient conditions of storage or transport and wherein said matrix material of the hypothermic environment is selected for compatibility with the subsequent cryogenic storage step,
whereby the conditions of the steps of hypothermic transport/storage maintain cellular viability and autonomously prepare the harvested material for subsequent cryogenic freezing in vitro.

30. The method of claim 29 wherein temperature of the hypothermic environment is maintained with generation of stored records of at least interval portions of temperature history.

31. The method of either of claim 29, further comprising providing an ejection system for sterile specimen receptacle whereby said container is projected slightly from secondary containment receptacle as cap is removed from secondary containment receptacle to accommodate for ease of access to specimen container during use:

32. The method of either of claim 29, further comprising providing a catch system for possible overflow of the matrix material upon inserting harvested material therein to offset the possibility of escape of non-sterile elements, if any, of the harvested material.

33. The method of claim 32, wherein absorbent material is provided in the catch system.

34. A hypothermic storage/transport apparatus for mammalian cellular material comprising:
a dual walled vessel for containing the material, comprising: (i) primary, water tight receptacle capable of 95 kPa (0.95 bar, 13.8 lb/in2) in the range of −40° C. to 55° and (ii) secondary, water tight containment receptacle capable of the same pressure limits;
a fluent matrix material in the vessel;
means for suspending the mammalian cellular material in the matrix within the vessel without touching its walls;
an air space surrounding the vessel and enclosed by insulating barriers which do not touch the vessel walls, in turn surrounded by exterior surfaces to complete a storage/transport package; and
means for cooling the air between the vessel to and maintaining its temperature at about 34-50 degrees Fahrenheit.

35. The apparatus of claim 34, further comprising means for monitoring air space and/or wall temperature during at least some intervals transport/storage and means for safe ejection of primary specimen receptacle whereby said container is projected slightly from secondary containment receptacle as cap is removed from containment receptacle during use and includes vial support area and work station.
